(19) United States
(12) Patent Application Publication
(10) Pub. No.: US 2008/0057182 A1
(43) Pub. Date: Mar. 6, 2008

(54) METHOD FOR GAP FILL IN CONTROLLED AMBIENT SYSTEM

(76) Inventors: John Boyd, Hillsboro, OR (US); Yezdi Dordi, Palo Alto, CA (US); Tiruchirapalli Arunagiri, Fremont, CA (US); Benjamin W. Mooring, Austin, TX (US); John Parks, Hercules, CA (US); William Thie, Mountain View, CA (US); Fritz C. Redeker, Fremont, CA (US); Arthur M. Howald, Pleasanton, CA (US); Alan Schoepp, Ben Lomond, CA (US); David Hemker, San Jose, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/611,758

(22) Filed: Dec. 15, 2006

Related U.S. Application Data
(63) Continuation-in-part of application No. 11/513,634, filed on Aug. 30, 2006.

(51) Int. Cl. B05D 5/12; B05D 1/36

(52) U.S. Cl. 427/58; 427/402

(57) ABSTRACT

A method for filling a trench of a substrate in a controlled environment is provided. The method initiates with etching a trench in the substrate in a first chamber of a cluster tool. A barrier layer configured to prevent electromigration is deposited over an exposed surface of the trench in a second chamber of the cluster tool and the trench is filled with a gap fill material deposited directly onto the barrier layer in the cluster tool. A semiconductor device fabricated by the method is also provided.

### CLAIM OF PRIORITY

This application is a continuation-in-part of U.S. application Ser. No. 11/513,634, filed on Aug. 30, 2006, and entitled “Processes and Systems for Engineering a Copper Surface for Selective Metal Deposition”, and is herein incorporated by reference.

### CROSS REFERENCE TO RELATED APPLICATION

This application is related to U.S. application Ser. No. 11/514,038, filed on Aug. 30, 2006, and entitled “Processes and Systems for Engineering a Barrier Surface for Copper Deposition”, and U.S. application Ser. No. 11/513,446, filed on Aug. 30, 2006, and entitled “Processes and Systems for Engineering a Silicon-Type Surface for Selective Metal Deposition to Form a Metal Silicide”, both of which are incorporated herein by reference. Further, this application is related to U.S. application Ser. No. 11/461,415, titled “System and Method for Forming Patterned Copper lines Through Electroless Copper Plating,” filed on Jul. 27, 2006, and is herein incorporated by reference. Additionally, this application is related to U.S. application Ser. No. ______ (Attorney Docket No. LAM2P565A), entitled Controlled Ambient System for Interface Engineering and filed on Dec. 15, 2006 which is herein incorporated by reference.

### BACKGROUND

Semiconductor processing is generally preformed in a highly controlled manner, with strict controls on environments and tool operations. Clean rooms that house these tools, for instance, must meet strict requirements that limit the amount of particles that can be generated during operation, and other controlled parameters. Substrates, when in process, may be required to move between many systems, and many times, the movements between the systems are repeated many times depending on the desired devices, layers and structures that need to be processed to create an integrated circuit device.

Although semiconductor equipment must meet tight regulations to qualify for production of semiconductor wafers, these regulations are most usually coupled to the individual tools. In operation, if a wafer needs to be processed in a wet tool, the tool completes its processing and then the substrate will have to be transported to another tool, which may be dry. In production, these substrates may be moved between tools using clean room automated systems. Typically, substrates are transported or moved in closed containers, and then coupled to other tools. Thus, if a plasma processing operation is needed, the substrate(s) may be moved to a cluster tool, which is defined by one or more transfer modules and dry processing modules.

Plasma processing modules are generally tied together in a cluster, but the cluster is limited to types of plasma processing or processes having a same ambient. That is, if the processing is dry (e.g., plasma processing), the substrate will be handled within that cluster until the process requires movement to a different type of system. Transport of the substrates between modules and clusters is handled in a very careful manner, however, substrates are exposed to oxygen during the transport. The oxygen may be the oxygen present in the clean room (or closed containers), and although the environment is controlled and clean, exposure to oxygen during a movement can cause oxidation of features or layers, before a next operation can be performed. Many times, the simple known exposure to oxygen during transport within the clean room causes fabrication sequences to include additional oxide removal steps, at more cost and cycles. However, even if oxide removal steps are performed, the queue time before a next step may still cause the generation of some oxidation.

In view of the foregoing, there is a need for systems, structures and methods for handling substrates during the fabrication process, while avoiding unnecessary exposure to an uncontrolled ambient, which will enable process efficiencies.

### SUMMARY

Broadly speaking, the embodiments fill the need by providing cluster architectures for processing substrates, and method for enabling the transitions among the modules of the cluster. The processing of substrates is performed in a controlled ambient environment during each stage of processing, as well as during transfers between one or more transfer modules to enable the direct plating onto a barrier layer and avoid the need for a seed layer for the gap fill process. It should be appreciated that the present invention can be implemented in numerous ways, including as a solution, a method, a process, an apparatus, or a system. Several inventive embodiments of the present invention are described below.

In one embodiment, a method for filling a trench of a substrate in a controlled environment is provided. The method initiates with etching a trench in the substrate in a first chamber of a cluster tool. A barrier layer configured to prevent electromigration is deposited over an exposed surface of the trench in a second chamber of the cluster tool and the trench is filled with a gap fill material deposited directly onto the barrier layer in the cluster tool.

In another embodiment, a method for performing a gap fill without applying a seed layer on a substrate is provided. The method includes depositing a first barrier layer over a substrate surface having a trench defined therein. A second barrier layer is deposited over the first barrier layer and an open area of the trench is filled with a conductive material deposited directly onto a surface of the second barrier layer.

A semiconductor device fabricated by a process comprising method operations of etching a feature in a substrate in a first chamber of a cluster tool, depositing a barrier layer configured to prevent diffusion of copper into an exposed surface of the feature in a second chamber of the cluster tool; and filling the feature with a gap fill material deposited directly onto the barrier layer.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows an example system diagram, and the computer control that may manage the system for particular engineered fabrication operations, in accordance with one embodiment of the present invention.

FIG. 2 illustrates an exemplary cluster architecture, which may implement the controlled ambient processing, in accordance with one embodiment of the present invention.

FIG. 3 is a simplified schematic diagram illustrating layers of a substrate for processing in accordance with one embodiment of the invention.

FIG. 4 illustrates layer 300 with a trench etched therein.

FIG. 5 is a simplified schematic diagram illustrating a conformal barrier layer being deposited over the exposed surface of the substrate and the exposed surface of trench 304.

FIG. 6 is a simplified schematic diagram illustrating a second conformal layer disposed over barrier layer 306.

FIG. 7, a copper fill is performed within the trench to yield copper line 310 after a planarization process is performed.

FIG. 8 is a flow chart diagram illustrating the method operations for performing the gap fill directly onto a barrier layer, thereby eliminating the need for a PVD seed layer in accordance with one embodiment of the invention.

### DETAILED DESCRIPTION

Several exemplary embodiments are disclosed, which define example cluster architectures for processing substrates, and method for enabling the transitions among the modules of the cluster. The processing of substrates is performed in a controlled ambient environment during each stage of processing, as well as during transfers between one or more transfer modules. By providing an integrated cluster architecture, which defines and controls the ambient conditions between and, in disparate clustered systems, it is possible to fabricate different layers, features, or structures immediately after other processing in the same overall system, while preventing the substrate from coming into contact with an uncontrolled environment (e.g., having more oxygen or other undesired elements and/or moisture than may be desired). It should be appreciated that the present invention can be implemented in numerous ways, including a process, a method, an apparatus, or a system. Several inventive embodiments of the present invention are described below. It will be apparent to those skilled in the art that the present invention may be practiced without some or all of the specific details set forth herein.

One application, which can benefit from the controlled ambient conditions of the defined embodiments, is electroless deposition of metal layers, which is highly dependent upon the surface characteristics and composition of the substrate. For example, electroless plating of copper on a barrier metal, such as tantalum (Ta) or ruthenium (Ru) surface is of interest for both seed layer formation prior to electroplating, and selective deposition of copper (Cu) lines within a lithographically defined pattern.

The main problem, now overcome by the defined embodiments of the present invention, is the inhibition of the electroless deposition process by atomically thin native metal oxide layers formed in the presence of oxygen (O₂). Similar issues existed with selective capping on Cu lines, as well as other applications. An example layer/material is a cobalt-alloy capping layer, which may include CoWP (cobalt tungsten phosphide), CoWB (cobalt tungsten boride), or CoWBP (cobalt tungsten boro-phosphide). Capping layers are used to improve adhesion of dielectric barrier layers to the copper lines, and thus improve electro-migration performance of those lines.

Therefore, proper management of an engineered interface (e.g., surface preparation sequence prior to deposition) is critical. The engineered interface may be for a layer, features, or materials. Thus, preparing an atomically pure surface and maintaining a pure interface is facilitated by the ambient controlled architecture defined herein, which provides the appropriate surface preparation sequences in a controlled ambient manner. For example, in a CoWBP capping process, the electrolytic chemistry is formulated to provide selectivity of the deposition on exposed Cu over adjacent dielectric.

In some examples, the wafer surface and various interfaces prior to electroless plating are determined by the upstream processes, usually a CMP and post-CMP clean sequence. In both cases, galvanic effects and corrosion are controlled by passivating the Cu surface with BTA, forming a Cu—BTA complex. This metal-organic hybrid must be removed prior to plating, or plating will be inhibited. Additionally, the dielectric surface must be free of Cu and it's oxides, and the Cu surface must be free of Cu oxides. In one embodiment, these conditions are satisfied by the ambient controlled clustered modules, which prevent unwanted exposure to ambient conditions that may be counterproductive to the desired fabrication operation.

One example difference between prior art systems and those of the present invention, is that previous module clusters do not control the ambient at all times, both within the process chambers and within the transfer chambers, so that the interface remains controlled and stable from one process sequence to the next. Without a controlled ambient, the prepared interface can degrade or change almost instantaneously, even with minimal queue time.

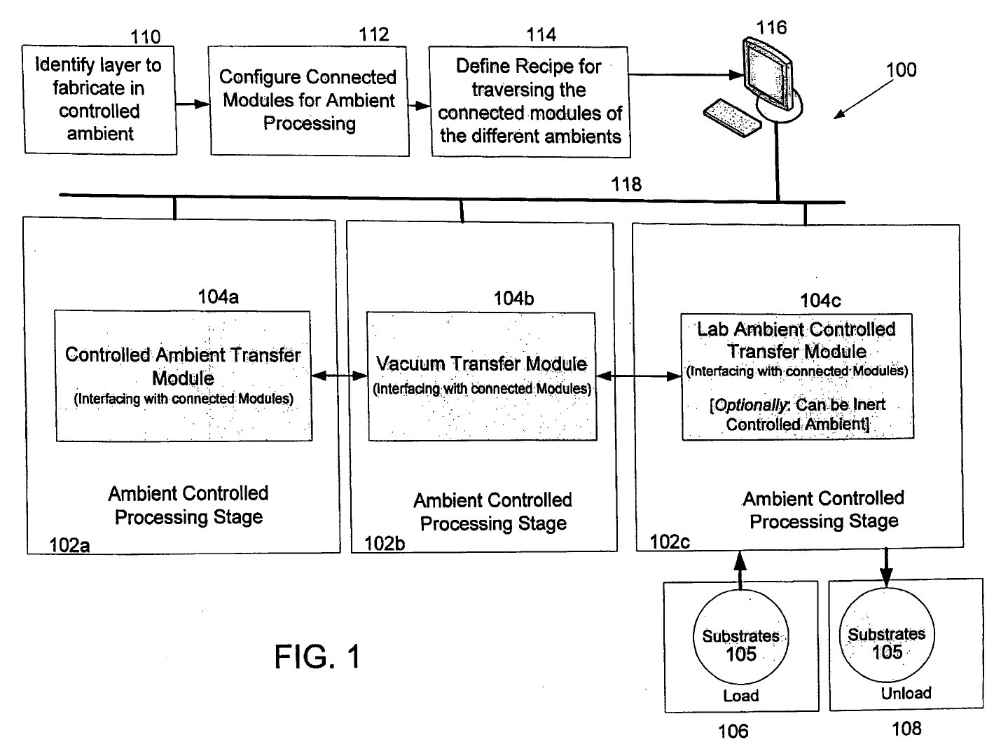

With the above overview in mind, reference is now made to exemplary structure configurations, which will enable processing of substrates in a controlled ambient environment. FIG. 1 illustrates an ambient controlled cluster system 100, in accordance with one embodiment of the present invention. The ambient controlled cluster system 100 includes a number of ambient controlled processing stages 102a, 102b, and 102c. Each of these ambient controlled processing stages are interconnected in such a way that the ambient conditions in each of the stages is maintained, as well as controlled ambient transitions between the different stages. Each of these ambient controlled processing stages 102a-102c, may be viewed as first, second, and third ambient environments. The order of the first, second and third ambient environments is not a limitation, as transitions among the ambient environments is dictated by the specific chosen recipe and engineered sequence of traversal through the transfer modules and process modules.

In one embodiment, the ambient controlled cluster system 100 is configured to enable precise processing of a layer or feature of a semiconductor substrate, such as a semiconductor wafer. The layer or feature to be fabricated on a particular wafer will depend on the stage of processing. For example, the processing may be for front end of line (FEOL), back end of line (BEOL), or any processing sequence or steps in between. An example is now provided where the ambient controlled cluster system 100 is used to fabricate a layer or feature(s), in a controlled ambient environment.

In operation 110, a layer to fabricate is identified, so that the layer can be fabricated through the various stages 102 of the ambient controlled cluster system 100. Once the layer or feature has been identified in operation 110, an operation 112 is performed to configure connection of different modules, in each of the ambient controlled processing stages, to enable the desired processing. Each of the ambient controlled processing stages 102 will include a primary transfer module that will interface with locally connected processing modules. For example, ambient controlled processing stage 102c may include a lab-ambient controlled transfer module 104c, ambient controlled processing stage 102b may include a vacuum transfer module 104b, and ambient controlled processing stage 102a may include a controlled ambient transfer module 104a.

Each of the transfer modules 104 will therefore be interconnected with a controlled transition (e.g., load locks), and are configured to accept different processing modules for interconnection therewith, depending on the configuration required for processing a layer or feature, at a particular stage in the process. In operation 114, a recipe for traversing the connected modules of the different ambients is defined, and inputted to a user interface 116.

User interface 116 may be a computer having a screen and keyboard for communicating with the ambient controlled cluster system 100. The user interface 116 may be a networked computer that is connected to other system computers for remote interaction with the ambient cluster system 100. The user interface 116 will also enable users to input specific recipes defined in operation 114, for moving the substrate between the different transfer modules 104 and the process modules connected to each of the transfer modules 104. In a specific embodiment, the ambient controlled cluster system 100 will reside in a clean room environment, which will then be connected to facilities. The facilities of a clean room, as is known, will provide each of the ambient controlled processing stages 102 required fluids, gasses, pressures, cooling, heating, chemistries, and the like.

In this example, a load module 106 is configured to provide substrates 105 into the ambient controlled processing stage 102c, at the direction of code run at the user interface 11 6, which controls the transfer of substrates into the ambient controlled cluster system 100. An unload module 108 may receive substrates 105, that have been processed within the confines of the ambient controlled processing stages 102. Although the load module 106 and unload module 108 are illustrated at two separate modules, it should be understood that the load module and unload module may be the same type of module, or that substrates are sent from, and received by, the same load port module.

In one embodiment, the lab-ambient controlled transfer module 104 is configured to receive substrates 105. Once the substrates 105 are transmitted into the lab-ambient controlled transfer module 104c, the lab-ambient controlled transfer module 104c may operate at a pressure that is slightly above an uncontrolled ambient pressure, which may be present in the clean room.

In this manner, if the pressure is slightly higher in the lab-ambient control transfer module 104c, the interfacing of substrates 105 into and out of the lab-ambient controlled transfer module 104c, will cause a slight flow of air out of the lab-ambient controlled transfer module 104c. The slight flow of air out of the lab-ambient control transfer module 104c will ensure that particulates or other ambient air that may be present in the clean room does not filter into the lab-ambient controlled transfer module 104c, when a door or doors are open to transition the substrates 105 into and out of the lab-ambient controlled transfer module 104c.

In one embodiment, the lab-ambient controlled transfer module 104c may optionally operate in an inert controlled ambient. An inert controlled ambient is one that may pump out oxygen and replace the oxygen with an inert gas. Examples gases that can be pumped in to replace oxygen may be, for example, argon, nitrogen, and other gasses that will not negatively react with the processing. The inert controlled ambient, if optionally provided for the lab-ambient controlled transfer module 104c, may also be communicated to the processing modules connected thereto. For instance, any wet cleaning that is performed in modules connected to the lab-ambient controlled module 104c, will also be controlled in the inert controlled ambient.

The lab-ambient controlled transfer module 104c will therefore interface the substrates 105 that are moved into and out of various wet processing systems within the ambient controlled processing stage 102c, and enable transition of substrates processed in the ambient controlled processing stage 102c into a vacuum transfer module 104b. Transitions into the vacuum transfer module 104b will occur in a controlled manner through one or more load locks. Once a substrate resides within the vacuum transfer module 104b, the substrates 105 are allowed to move into and out of various plasma processing modules to enable desired processing. The vacuum transfer module 104b is also shown coupled to the controlled ambient transfer module 104a.

Transition of a substrate 105 between 104b and 104a will also be facilitated through one or more load locks, to ensure that the integrity of the vacuum transfer module pressure 104b remains, while enabling the substrate 105 to transition into an ambient that is controlled to avoid inappropriate exposure of just processed layers or features within 104, to be exposed to an ambient that may destroy are negatively alter such layers or features. In one example, when a substrate 105 that has been processed within the ambient controlled processing stage 102b, and is thus moved into the ambient controlled processing stage 102a, the feature or layer that has been plasma processed is not compromised by any uncontrolled exposure to an ambient that may damage or chemically alter the just processed feature or layer.

As an example, the controlled ambient transfer module 104a will operate in an inert ambient. As noted above, an inert ambient is one that is pumped with an inert gas, which should deplete or reduce the existence of most oxygen within the ambient controlled processing stage 102a. As an example, a level of oxygen that is acceptable and still viewed as substantially oxygen free may be 3 ppm. (parts per million), or less. Some processes may require less than 1 ppm control after a surface treatment prior to and during subsequent processing. By configuring the inert environment within the ambient controlled processing stage 102a, it is possible to avoid oxidation or hydroxylation of features or layers that may have been just fabricated within the ambient controlled processing stages 102b or 102c. Within the controlled ambient transfer module 104a, various processing modules will allow the controlled deposition, coating, plating, or processing of a layer or features over the substrate 105, without having any intermediate oxidation of layers or features. As such, the layer that is formed within the controlled ambient transfer module processing stages is controlled, and in one embodiment, is said to be “engineered” to avoid unnecessary formation of oxides, which may reduce the performance of the processed layer or feature(s).

At this point, the substrate 105 may be moved back into the vacuum transfer module 104b for further processing with a plasma processing module, or back to the lab-ambient control transfer module 104c, for additional processing within modules connected thereto. The specific processes of moving the substrate 105 between any of the ambient control processing stages 102a, 102b, and 102c, will be dependent upon the defined recipe identified in operation 114, which is controlled by a program executed on a computer connected to the user interface 116.

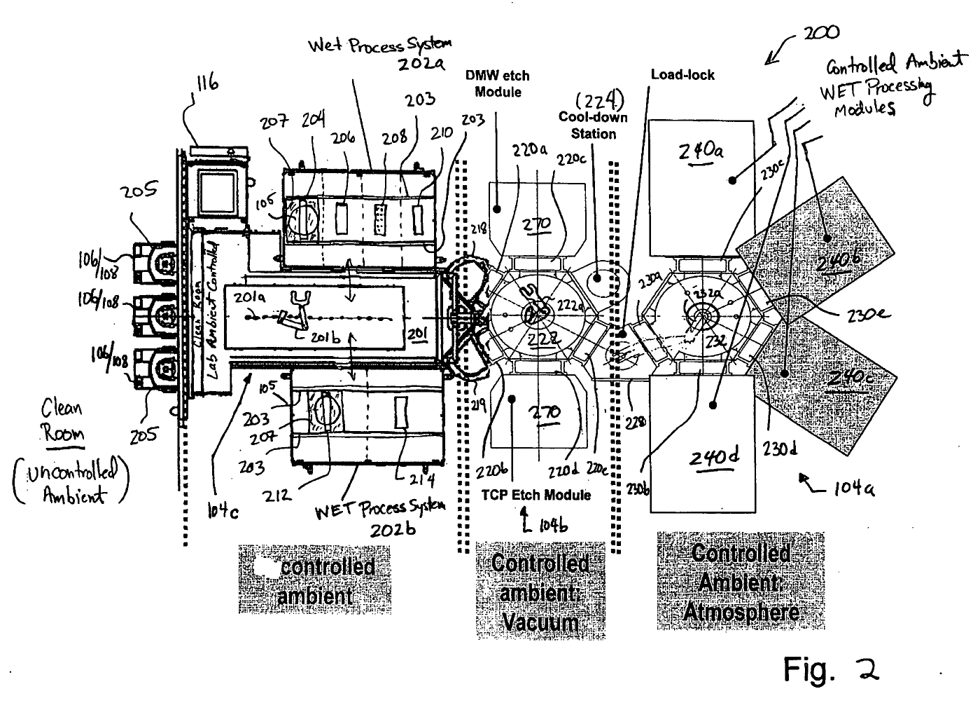

FIG. 2A illustrates a cluster architecture 200 that includes a number of transfer modules and processing modules connected thereto. The cluster architecture 200 is one example of specific processing modules that may be connected to the various transfer modules in the ambient controlled processing stages 102a, 102b, and 102c.

The cluster architecture 200 will be explained from left to right, where substrates can be loaded and unloaded in the load modules 106 and unload modules 108. As discussed above, the load modules 106 and unload modules 108 may be generally referred to as load-unload stations that may be configured to receive cassettes 205, that hold one or more wafers. The cassettes 205 may be contained within Front Opening Unified Pods (FOUPs) that are used to transport wafers around a clean room. The handling of FOUPs that hold cassettes 205 may be automated or manually handled by human operators. The substrates 105 will therefore be contained within the cassettes 205 when delivered to the cluster architecture 200, or received from the cluster architecture 200. As defined herein, the clean room is the uncontrolled ambient in which the cluster architecture 200 sits or is installed.

The lab-ambient controlled transfer module 104c is defined by a stretch transfer module 201, that includes one or more end effectors 201b. The illustrated end effector 201b is capable of traversing the stretch transfer module 201 when moved along a track 201a. In one embodiment, the stretch transfer module 201 is kept at a standard clean room pressure. Alternatively, the pressure may be controlled to be slightly above the ambient pressure of the clean room, or slightly below the pressure of the clean room.

If the pressure within the stretch transfer module 201 is kept at a pressure slightly above the clean room, transitions of wafers into and out of the stretch transfer module will cause a slight outgas of the transfer module ambient into the clean room. This configuration may thus prevent particulates or the environment air within the clean room to flow into the stretch transfer module 201.

In other embodiments, the transition between the stretch transfer module 201 and the clean room will be controlled by appropriate filters and air handling units that will define a curtain or interface of air and/or environment, so as to prevent interaction of the ambient air between the clean room and the stretch transfer module 201. An example of a system for controlling the interface is defined in U.S. Pat. No. 6,364,762, entitled “Wafer Atmospheric Transport Module Having a Controlled Mini-Environment”, which issued on Apr. 2, 2002, to the assignee of the present application, and is herein incorporated by reference.

The stretch transfer module 201 is shown interfaced with wet processing system 202a and wet processing system 202b. Each of wet processing systems 202 may include a number of sub-modules, within which substrate 105 may be processed. In one example, a carrier 207 is allowed to move along a track 203 within the wet process systems 202a. The carrier 207 is configured to hold the substrate 105, as it is processed in each of the sub-modules of the wet processing system 202. In one example, the wet processing system 202a will include a proximity station 204, followed by a proximity station 206, followed by a brush station 208, and then a final proximity station 210.

The number of sub-modules within the wet processing system 202a are dependent on the particular application and the number of wet processing steps desired to be performed on a particular substrate 105. Although four sub-modules are defined in wet processing system 202a, an example of two sub-modules within the wet processing system 202b is provided. The proximity station 204 is composed of a proximity head system which utilizes a meniscus to apply and remove fluids onto a surface of the substrate 105, as the substrate 105 is caused to move along the track 203, so that the meniscus can be applied over the entire surface of the substrate 105.

In specific embodiments, the proximity stations may be configured to apply DI water for simple cleaning, HF (hydrofluoric acid), ammonia-based cleaning fluids, standard clean 1 (SC1), and other etching and cleaning chemicals and/or fluid mixtures. In a specific embodiment, the proximity stations will include proximity heads that will process both top and bottom surfaces of the substrate 105. In other examples, only a top surface may be processed by a proximity head while the bottom surface may be unprocessed, or processed by a brush station roller. The combination of processing operations performed within the wet processing system's 102a will therefore vary, depending upon the processing required for a particular substrate in its recipe of fabrication.

It will be understood that the stretch transfer module 201 is configured to allow substrates 105 to be moved into and out of either particular sub-modules within the wet processing system 202, or into a single processing sub-module of the wet processing system 102a and then removed at the end of the line of the wet processing system 201. For additional throughput, the wet processing system 201 is provided such that one system is coupled to each side of the stretch transfer module 201. Of course, the lab-ambient control transfer module defined by the stretch transfer module 201, may include fewer or more wet processing systems, depending upon the throughput required, available lab footprint or facilities, and/or processing required.

The stretch transfer module 201 is shown coupled to load locks 218 and 219. The load locks 218 and 219 are configured to allow transition from one pressure state to another in a controlled manner between the stretch transfer module 201 and a vacuum transfer module 222. The vacuum transfer module 222 will include an end effecter robot 222a. The end effecter 222a is configured to reach into and out of the load locks 218 and 219 when access is provided by slot valves 220a and 220b. The slot valves will house a door or multiple doors that allow opening and closing of the vacuum transfer module 222, so that the pressure within the vacuum transfer module is uninterrupted. Thus, the doors of the slot valves 220a and 220b enable transitions between the load locks 218 and 219, which serve to control the transfer between the stretch transfer module 201 and the vacuum transfer module 222 which may be at different pressure states.

The vacuum transfer module 222 is also shown interfaced with plasma modules 270, by way of slot valves 220c and 220d. The plasma modules 270 may be of any type, but a specific example may be a TCP etch module and a downstream microwave etch module. Other types of plasma modules may also be incorporated. Some plasma modules may include types of deposition modules, such as plasma vapor deposition (PVD), atomic layer deposition (ALD), etc. Thus, any dry processing modules that removes or deposits material onto the surface or surfaces of a substrate may be incorporated and connected to the vacuum transfer module 222.

Alternatively, thermal process modules can be used in addition, or in place of, plasma processing modules. In this case, it may be advantageous to operate the vacuum transfer module 222 at higher pressure, up to 400 torr, for example, to facilitate interface with the thermal modules.

If processing is performed in one of the plasma modules 270, the vacuum transfer module may incorporate a cool-down station 224. The cool-down station 224 is particularly beneficial when a substrate has been cooled to a point before transition into one of the neighboring controlled ambient stages. Once a substrate is cooled, if needed, the substrate may be moved into a load lock 228 by the end effecter 222a, for then transitioning into a controlled ambient transfer module 232. The controlled ambient transfer module 232 is interconnected with load lock 228 by way of slot valve 230a.

The controlled ambient transfer module 232 is shown interconnected with a number of process modules 240a, 240b, 240c, and 240d, through associated slot valves 230b, 230c, 230d, and 230e. The processing modules 240, in one embodiment, are controlled ambient wet processing modules. The controlled ambient wet processing modules 240 are configured to process a surface of a wafer in a controlled inert ambient environment. The controlled inert ambient environment, as noted above, is configured such that an inert gas is pumped into the controlled ambient transfer module 232, and oxygen is purged out of the controlled ambient transfer module 232.

By removing all or most of the oxygen from the controlled ambient transfer module 232 and replacing it with an inert gas, the controlled ambient transfer module 232 will provide a transition environment which does not expose a just process substrate (e.g., within a plasma module 270) before a layer is either deposited, plated, or formed onto a processed surface or feature in one of the process modules 240. In specific embodiments, the processed modules 240 may be electroplating modules, electroless plating modules, dry-in/dry-out wet process modules, or other types of modules that will enable the application, formation, or deposition of a layer on top of a surface or feature that has been just processed in a prior plasma module.

Additionally, the vacuum transfer module and the controlled ambient transfer module can be configured to be integrated in reverse order to facilitate other process sequences.

The result is an engineered layer that is formed directly over a surface that has just been processed, and does not contain oxides that are typically formed when even minor exposure to oxygen occurs before a layer is plated thereon. In one specific example, a dielectric layer may be etched to define a via and/or trench within plasma modules 270, and immediately after the vias or trenches are defined in the dielectric layer, a transfer occurs between the vacuum transfer module 222 through load lock 228 and into the controlled ambient transfer module 232. This transfer occurs without or substantially without exposure to oxygen. In some processes, a barrier layer may be fabricated directly over the surface of the engineered interface. The barrier layer may include, for example, Ta, TaN, Ru, or combinations of these materials etc. etc. The barrier layer may be used for electroless plating of Cu as a seed layer or to plate directly on a patterned substrate. For more information on direct plating, reference can be made to: (1) U.S. patent application Ser. No. 11/382,906, filed on May 11, 2006, and entitled “PLATING SOLUTION FOR ELECTROLESS DEPOSITION OF COPPER”, (2) U.S. patent application Ser. No. 11/427,266, filed on Jun. 28, 2006, and entitled “PLATING SOLUTIONS FOR ELECTROLESS DEPOSITION OF COPPER,” (3) U.S. patent application Ser. No. ______ (Attorney Docket No. LAM2P588), filed on Dec. 13, 2006, and entitled “SELF ASSEMBLED MONOLAYER FOR IMPROVING ADHESION BETWEEN COPPER AND TANTALUM,” (3) U.S. patent application Ser. No. ______ (Attorney Docket No. LAM2P583), filed on Oct. 31, 2006, and entitled “Methods of Fabricating a Barrier Layer with Varying Composition for Copper Metallization,” AND (4) U.S. patent application Ser. No. 11/552,794, filed on Oct. 25, 2006, and entitled “APPARATUS AND METHOD FOR SUBSTRATE ELECTROLESS PLATING,” each of which is incorporated herein by reference.

FIGS. 3-8 provide exemplary embodiments for direct copper plating onto a barrier film, which is enabled by the substantially free oxygen environment of FIG. 2. FIG. 3 is a simplified schematic diagram illustrating layers of a substrate for processing in accordance with one embodiment of the invention. Layer 300 is disposed over substrate 302. It should be appreciated that layer 300 will be an interlayer dielectric (ILD).

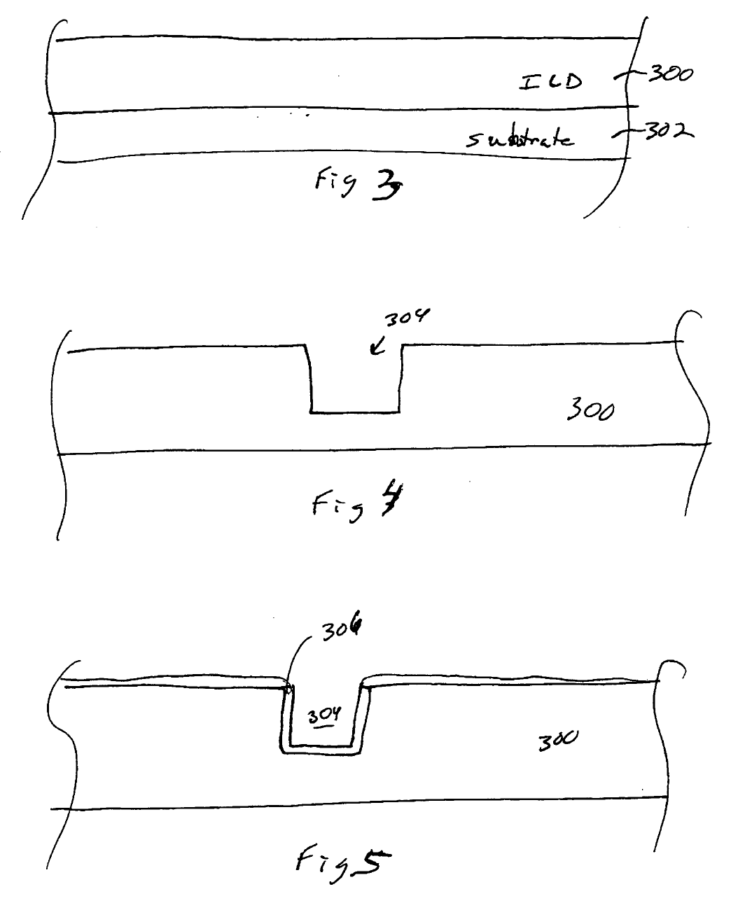

FIG. 4 illustrates layer 300 with an etched feature therein. The feature may be one of a contact, via, trench or other void made in the semiconductor material such that subsequent metallization provides an interconnect to other devices. In some processes such as dual damascene etch processes a sequence of via and trench etches are utilized to define a feature within dielectric layers prior to metallization. In one embodiment, void 304 has been etched within layer 300 through known etch processing techniques. For example, a plasma etch may be used to form void 304 within layer 300. The plasma etch may take place in a plasma chamber of the cluster module of FIG. 2, which operates at controlled ambient under vacuum conditions. It should be noted that the term void and feature may be used interchangeably.

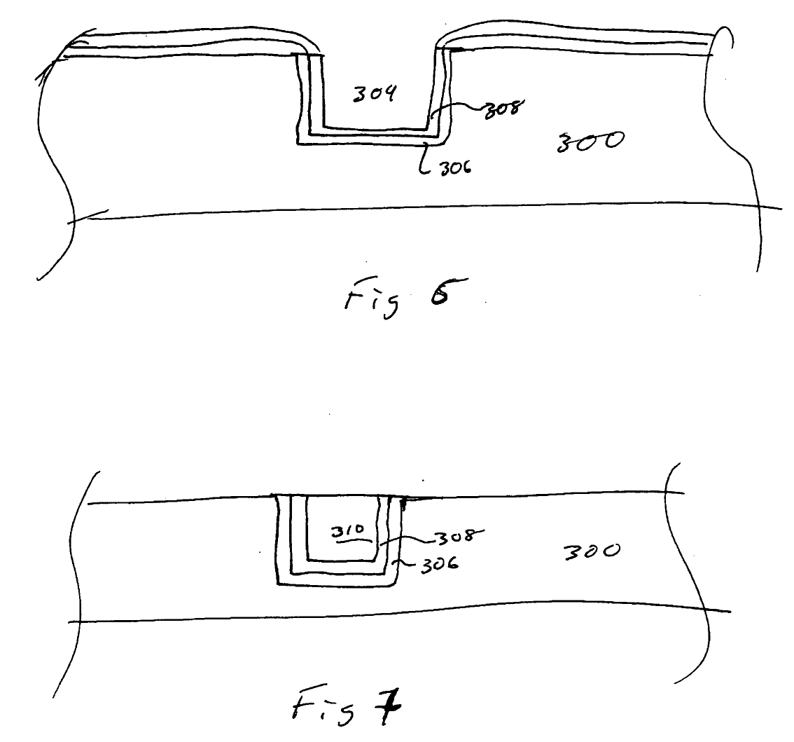

FIG. 5 is a simplified schematic diagram illustrating a conformal barrier layer being deposited over the exposed surface of the substrate and the exposed surface of void 304. Conformal barrier layer 306 is deposited through known deposition techniques in accordance with one embodiment of the invention. For example, the deposition may take place within a controlled ambient atmosphere module of the cluster architecture of FIG. 2. That is, any of modules 240a through 240d may be used to deposit the barrier layer through known deposition techniques. It should be appreciated that barrier layer 306 can be made of tantalum nitride (TaN), tantalum (Ta), Ruthenium (Ru), or a hybrid combination of these materials. While these are the commonly considered materials, other barrier layer materials can also be used. Barrier layer materials may be other refractory metal compound including but not limited to titanium (Ti), tungsten (W), zirconium (Zr), hafnium (Hf), molybdenum (Mo), niobium CNb), vanadium (V), ruthenium (Ru), iridium (Ir), platinum (Pt), and chromium (Cr), among others.

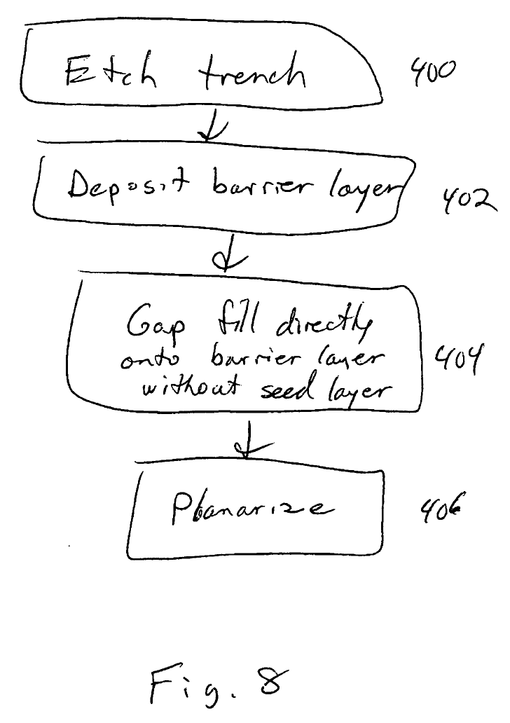

FIG. 6 is a simplified schematic diagram illustrating a second conformal layer disposed over barrier layer 306. Layer 308 is a tantalum layer in accordance with one embodiment of the invention. It should be appreciated that tantalum nitride (TaN) has acceptable adhesion properties for interlayer dielectric layer 300. However, tantalum nitride does not adhere as well as a tantalum layer to copper, which will be used to fill void 304 subsequently. As an alternative to FIG. 6, i.e., where two barrier layers are deposited, tantalum nitride layer 306 may be processed to have a tantalum-rich surface proximate to the copper which will be filled into void 304. In one embodiment, a functional layer or self assembled monolayer is deposited over the barrier layer. Further details on the process for using a single tantalum nitride layer and converting a portion of the layer to a tantalum-rich portion, i.e., enriching the barrier layer, disposed thereon are provided in U.S. application Ser. No. ______ (ATTY docket LAM2P588) entitled “Self Assembled Monolayer for Improving Adhesion Between Copper and Barrier Layer” and filed on Dec. 13, 2006 and U.S. application Ser. No. ______ (ATTY docket LAM2P578) entitled “Methods and Apparatus For Barrier Interface Preparation Of Copper Interconnect” and filed on Dec. 13, 2006, both of which are incorporated by reference. It should be appreciated that layers 306 and 308 may both be deposited through deposition modules defined on the controlled ambient processing system of FIG. 2. In FIG. 7, a copper fill is performed within the trench to yield copper line 310 after a planarization process is performed. Copper line 310 is illustrated within barrier layers 308 and 306, which are defined within interlayer dielectric 300. It should be appreciated that in FIG. 6 the copper fill is performed and then a planarization step is followed in order to planarize the top surface to obtain the lines as illustrated in FIG. 7. In one embodiment, the planarization takes place in the controlled ambient wet processing modules defined in FIG. 2. One such planarization method may use the technique described in U.S. application Ser. No. 11/394,777 entitled “Apparatus and Method for Semiconductor Wafer Electroplanarization,” filed on Mar. 31, 2006. As illustrated in FIGS. 3 through 7, the copper gap fill is performed without the need for a PVD seed layer. Because of the controlled ambient environment defined within FIG. 1, the PVD seed layer may be eliminated enabling the copper fill to be performed directly onto the barrier layers. Thus, in one embodiment, the copper fill can be directly performed on barrier layer 308 where tantalum is deposited over a tantalum nitride barrier layer. In another embodiment, the copper fill can be performed directly onto barrier layer 306 where barrier layer 306 has been tantalum enriched so that the copper fill will adhere properly.

FIG. 8 is a flow chart diagram illustrating the method operations for performing the gap fill directly onto a barrier layer, thereby eliminating the need for a PVD seed layer in accordance with one embodiment of the invention. The method initiates with operation 400 where a void is etched. The void is etched through any known etching techniques. In one embodiment, the void is etched through modules of the system described in FIGS. 1 and 2 so that the substrate remains in a controlled environment atmosphere. The method then advances to operation 402 where a barrier layer is deposited within the etched trench. As described with regard to FIGS. 4 through 7, the barrier layer may be a tantalum nitride layer, or any other suitable layer that will prevent electromigration mentioned above. It should be appreciated that within the system defined by FIGS. 1 and 2, the substrate would be moved from the controlled ambient vacuum region to the controlled ambient atmospheric region for the deposition plating. The deposition of the barrier layers may occur as a tantalum nitride layer first and then a tantalum layer in one embodiment. In another embodiment, a tantalum nitride layer may be deposited and then enriched as described above. In either event, a tantalum-rich layer is defined for the gap fill process in order to ensure proper adhesion of the copper to the barrier layer. Next the gap fill is performed where copper is deposited into the trench directly onto the barrier layer as specified in operation 404. As described above, these processes eliminate the need for a PVD seed layer defined within the barrier layer. That is, the copper is filled directly onto the barrier layers without the seed layer. The overburden from the gap fill is then planarized in order to provide a smooth top surface for the interlayer dielectric as specified in operation 406. In one embodiment, the electroplanarization technique discussed with regard to U.S. Ser. No. 11/394,777 is performed in one of the controlled ambient wet processing modules of the cluster architecture.

The control systems and electronics of that manage and interface with the cluster architectures modules, robots, and the like, may be controlled in an automated way using computer control. Thus, aspects of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While this invention has been described in terms of several embodiments, it will be appreciated that those skilled in the art upon reading the preceding specifications and studying the drawings will realize various alterations, additions, permutations and equivalents thereof. Therefore, it is intended that the present invention includes all such alterations, additions, permutations, and equivalents as fall within the true spirit and scope of the invention. In the claims, elements and/or steps do not imply any particular order of operation, unless explicitly stated in the claims.

What is claimed is:

1. A method for filling a feature of a substrate in a controlled environment, comprising method operations of:
etching a feature in the substrate in a first chamber of a cluster tool;
depositing a barrier layer configured to prevent diffusion of copper into an exposed surface of the feature in a second chamber of the cluster tool; and
filling the feature with a gap fill material deposited directly onto the barrier layer.

2. The method of claim 1, further comprising:
planarizing the gap fill material.

3. The method of claim 1, further comprising:
enriching the barrier layer to improve adhesion properties to the gap fill material.

4. The method of claim 1, further comprising:
depositing another barrier layer over the barrier layer.

5. The method of claim 4, wherein the barrier layer is tantalum and the another barrier layer is tantalum nitride.

6. The method of claim 1, wherein the gap fill material is copper.

7. The method of claim 1, wherein each method operation is performed in a controlled environment.

8. The method of claim 1, further comprising:
transitioning the substrate between the first chamber and the second chamber without exposing the substrate to uncontrolled environmental conditions.

9. A method for performing a gap fill without applying a seed layer on a substrate, comprising:
depositing a first barrier layer over a substrate surface having a feature defined therein;
depositing a second barrier layer over the first barrier layer; and
filling an open area of the feature with a conductive material deposited directly onto a surface of the second barrier layer.

10. The method of claim 9, wherein the method operation of filling the open area of the feature is performed without applying a seed layer over the second barrier layer.

11. The method of claim 9, wherein the first barrier layer is tantalum nitride.

12. The method of claim 9, wherein the second barrier layer is tantalum.

13. The method of claim 9, wherein the conductive material is copper.

14. The method of claim 9, further comprising:
planarizing the surface of the substrate after filling the open area of the feature.

15. The method of claim 9, wherein the method operation of filling the open area of the feature is performed in a different chamber than the other method operations.

16. The method of claim 15, further comprising:
transitioning the substrate from a first chamber to a second chamber prior to performing the filling.

17. The method of claim 16 wherein the transitioning occurs in a substantially oxygen free environment.

18. The method of claim 9, wherein each method operation is performed in a substantially oxygen free environment.

19. A semiconductor device fabricated by a process comprising method operations of:
etching a feature in a substrate in a first chamber of a cluster tool;
depositing a barrier layer configured to prevent diffusion of copper into an exposed surface of the feature in a second chamber of the cluster tool; and
filling the feature with a gap fill material deposited directly onto the barrier layer.

20. The semiconductor device of claim 19, further comprising:
enriching the barrier layer to improve adhesion properties to the gap fill material deposited directly thereon.

21. The semiconductor device of claim 19, further comprising:
depositing another barrier layer over the barrier layer.

22. The semiconductor device of claim 21, wherein the barrier layer is tantalum and the another barrier layer is tantalum nitride.

23. The semiconductor device of claim 19, wherein the gap fill material is copper.

24. The semiconductor device of claim 19, wherein the feature is one of a trench or a via.
